(19) United States
(12) Patent Application Publication
(10) Pub. No.: US 2018/0021896 A1
(43) Pub. Date: Jan. 25, 2018

(54) LEAD-FREE SOLDER COMPOSITION

(71) Applicant: National Cheng Kung University, Tainan City (TW)

(72) Inventors: Kwang-Lung LIN, Taipei City (TW); Che-Wei CHANG, Chiayi City (TW); Wei-Chih HUANG, Tainan City (TW)

(21) Appl. No.: 15/601,535

(22) Filed: May 22, 2017

(30) Foreign Application Priority Data
Jul. 25, 2016 (TW) 105123411

(51) Int. Cl. B23K 35/32; C22C 14/00; C22C 13/00; B23K 1/08; C22C 18/00

(52) U.S. Cl. CPC B23K 35/325; B23K 1/08; C22C 18/00; C22C 13/00; C22C 14/00; B23K 2203/14

(57) ABSTRACT

A lead-free solder composition includes tin, titanium and zinc. Based on 100 parts by weight of the total weight of tin, titanium and zinc, tin is present in an amount ranging from 20 to 40 parts by weight, and titanium is present in an amount ranging from 0.01 to 0.15 parts by weight.

### CROSS REFERENCE TO RELATED APPLICATION

This application claims priority of Taiwanese Application Number 105123411, filed on Jul. 25, 2016.

### FIELD

The disclosure relates to a lead-free solder composition, and more particularly to a lead-free solder composition including tin, titanium and zinc.

### BACKGROUND

Conventional high-temperature lead-free solders that are well-known in the industry include gold-tin solder, bismuth-silver solder, zinc-aluminum solder and zinc-tin solder. Since gold and silver are considered more precious metals, gold-tin solder and bismuth-silver solder are more costly than zinc-aluminum solder and zinc-tin solder. Zinc-tin solder has the best mechanical strength and development potential of the above four solder compositions. Conventionally, the zinc-tin solder includes tin in an amount ranging from 20 to 40 wt %, where the remainder of the zinc-tin solder is mostly composed of zinc. However, zinc is easily oxidized, so that the zinc-tin solder is very susceptible to oxidation. Furthermore, although the mechanical strength of the zinc-tin solder is relatively greater than the other lead-free solders, the wettability of the zinc-tin solder is still unsatisfactory.

### SUMMARY

Therefore, an object of the disclosure is to provide a lead-free solder composition that can alleviate at least one of the drawbacks of the prior art.

The lead-free solder composition includes tin, titanium and zinc. Based on 100 parts by weight of the total weight of tin, titanium and zinc, tin is present in an amount ranging from 20 to 40 parts by weight, and titanium is present in an amount ranging from 0.01 to 0.15 parts by weight.

### BRIEF DESCRIPTION OF THE DRAWINGS

Other features and advantages of the disclosure will become apparent in the following detailed description of the embodiments with reference to the accompanying drawing, of which:

FIG. 1 is an SEM image of the microstructure of the lead-free solder composition of Comparative Example 1;

FIG. 2 is an SEM image of the microstructure of the lead-free solder composition of Example 2;

FIG. 3 is an SEM image of the microstructure of the lead-free solder composition of Example 5;

FIG. 4 is an SEM image of the microstructure of the lead-free solder composition of Example 7;

FIG. 5 is an SEM image of the microstructure of the lead-free solder composition of Example 8;

FIG. 6 is a thermogravimetric analysis (TGA) curve of the lead-free solder composition of each of Examples 2, 5, 7 and 8 and Comparative Example 1;

FIG. 7 is a stress-strain curve of the lead-free solder composition of each of Examples 1 to 6 and Comparative Example 1;

FIG. 8 is a titanium content-elongation curve of the lead-free solder composition of each of Examples 1 to 6 and Comparative Example 1;

FIG. 9 is titanium content-toughness curve of the lead-free solder composition of each of Examples 1 to 6 and Comparative Example 1; and

FIG. 10 is a plot of titanium content-contact angle of the lead-free solder composition of each of Examples 2, 5, 7 and 8 and Comparative Example 1.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

A lead-free solder composition includes tin, titanium and zinc.

Tin is present in an amount ranging from 20 to 40 parts by weight, based on 100 parts by weight of the total weight of tin, titanium and zinc. In certain embodiments, tin is present in an amount of 25 parts by weight based on 100 parts by weight of the total weight of tin, titanium, and zinc.

Zinc is present in an amount greater than that of tin, allowing the lead-free solder composition of the disclosure to have a relatively high melting point and to be used in a high temperature operating environment.

Titanium is present in an amount ranging from 0.01 to 0.15 parts by weight, based on 100 parts by weight of the total weight of tin, titanium and zinc.

Since titanium is easily oxidized, inclusion of a small amount of titanium in the lead-free solder composition of the disclosure would increase the density of an oxide layer formed on the solder surface, thereby improving the oxidation resistance of the lead-free solder composition.

Furthermore, inclusion of titanium in the lead-free solder composition of the disclosure would increase the strength thereof. To be specific, the melting point of titanium is approximately 1670□, which is much higher than the melting points of zinc and tin. Therefore, when the operation temperature is lower than the melting point of titanium but higher than the melting points of tin and zinc, titanium will remain solid and disperse among the molten metal solution of tin and zinc to become a seed crystal which would facilitate formation of a relatively large number of fine grains during the crystallization procedure. Thus, the lead-free solder composition of the disclosure having a greater number of fine grains will exhibit relatively great strength. However, not every metal with a high melting point may achieve the aforesaid effect; a metal that has a higher melting point than zinc and tin but may form a solid solution with zinc and tin prior to reaching its melting point would not be able to form a seed crystal.

In addition, inclusion of titanium in the lead-free solder composition of the disclosure may change the surface tension between the metals, so that the lead-free solder composition may have increased wettability.

In order to achieve the aforementioned advantages, as mentioned above, the amount of titanium may be limited in a range between 0.01 and 0.15 parts by weight based on 100 parts by weight of the total weight of tin, titanium and zinc. When the amount of titanium in the lead-free solder composition of the disclosure is less than 0.01 parts by weight, the oxidation resistance, strength, wettability and number of fine grains of the lead-free solder composition may not be increased. On the other hand, when the amount of titanium in the lead-free solder composition of the disclosure is greater than 0.15 parts by weight, the titanium may become unevenly distributed among the molten metal solution of tin and zinc, leading to a smaller number of seed crystals and consequently, a smaller number of fine grains.

In certain embodiments, titanium is present in an amount ranging from 0.01 to 0.05 parts by weight based on 100 parts by weight of the total weight of tin, titanium and zinc. Within such a range, the toughness and tensile strength of the lead-free solder composition of the disclosure may not significantly decrease.

In certain embodiments, titanium is present in an amount ranging from 0.01 to 0.03 parts by weight based on 100 parts by weight of the total weight of tin, titanium and zinc. With the aforesaid amount of titanium, the toughness, tensile strength, ductility and wettability of the lead-free solder composition may be improved, especially when the amount of titanium is 0.02 parts by weight. In general, the increased number of grain boundaries associated with the fine grains impedes dislocation movement, thus improving the tensile strength, but reducing the ductility and toughness. However, within the range of 0.01 to 0.03 parts by weight, although the number of grain boundaries is increased, the tensile strength, the ductility and toughness are also improved.

The disclosure will be further described by way of the following examples and comparative example. However, it should be understood that the following examples and comparative example are solely intended for the purpose of illustration and should not be construed as limiting the disclosure in practice.

### EXAMPLES

### Example 1 (E1)

Based on 100 parts by weight of the total weight of tin, titanium and zinc, 25 parts by weight of tin, 0.01 parts by weight of titanium, and 74.99 parts by weight of zinc were compounded together and heated to 500° C. to melt tin and zinc. Molten tin and zinc were then maintained at the molten state for 5.5 hours, along with non-molten titanium, to ensure that the molten tin and zinc and the non-molten titanium were evenly mixed. The evenly mixed molten tin and zinc and non-molten titanium were then poured into a stainless steel mold, followed by cooling to room temperature so as to obtain a lead-free solder composition of Example 1.

### Examples 2 to 8 (E2 to E8) and Comparative Example 1 (CE1)

The procedures and conditions in preparing the lead-free solder composition of Examples 2 to 8 were similar to those of Example 1, except for the amounts of titanium and zinc used (see Table 1).

The procedures and conditions in preparing the lead-free solder composition of Comparative Example 1 were similar to those of Example 1, except that the lead-free solder composition of Comparative Example 1 was free of titanium (see Table 1).

Based on the understanding of the inventors, lead-free solder compositions that includes zinc and tin, where the amount of tin ranges from 20 to 40 parts by weight, have similar properties. When the amount of tin is 25 parts by weight, the lead-free solder exhibits the best properties. Therefore, each of the examples of the disclosure contains 25 parts by weight of tin, and the amount of tin will not be further discussed herein.

### [Evaluation Methods]

### Microstructure Observation

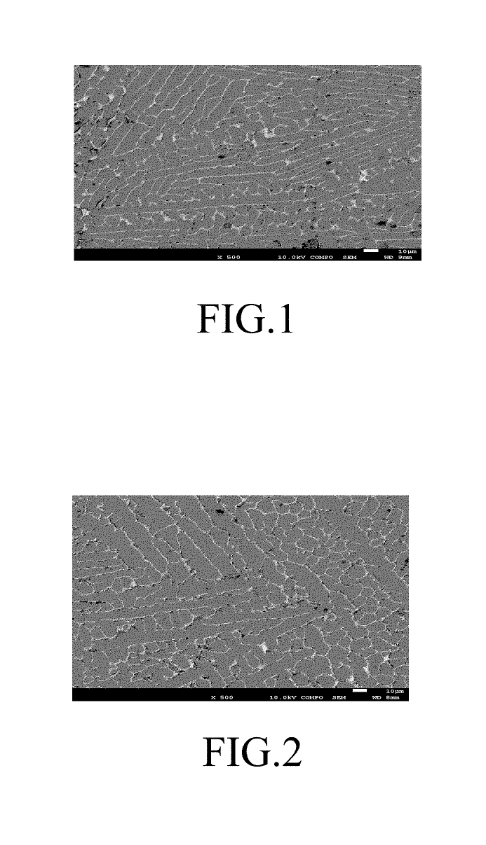

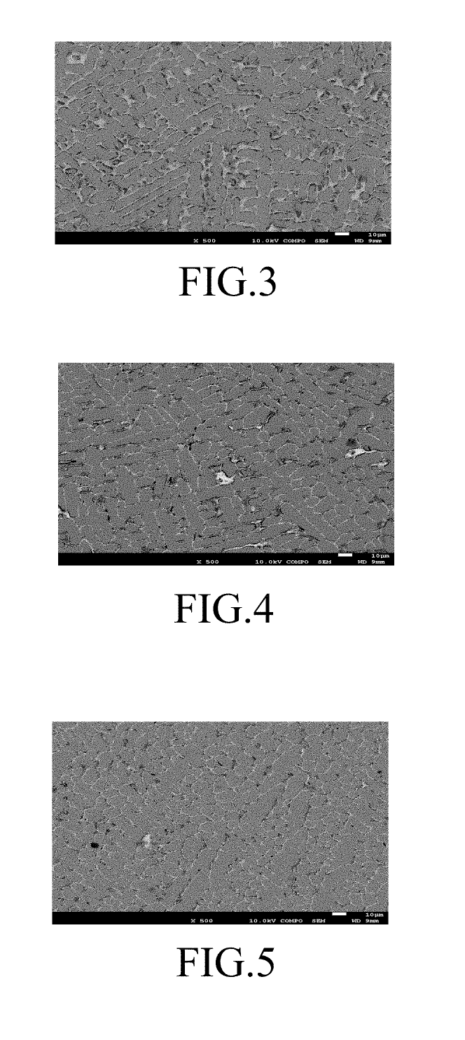

FIGS. 1 to 5 respectively show the SEM images of the lead-free solder compositions of Comparative Example 1 and Examples 2, 5, 7, and 8.

In each of the SEM images, the light gray lines show areas of the lead-free solder composition that are tin-rich phase (mainly composed of tin), and the dark gray grains show areas of the lead-free solder composition that are Zn-rich phase (mainly composed of zinc). The SEM images reveal that the dark gray grains of Comparative Example 1 (FIG. 1) are relatively larger in size, more elongated in shape, and fewer in number as compared to the grains of Examples 2, 5, 7, and 8 (FIGS. 2 to 5).

### Oxidation Resistance Test

A 10 mg sample of the lead-free solder composition of each of Comparative Example 1 and Examples 2, 5, 7, and 8 was subjected to thermogravimetric analysis under an argon atmosphere. The temperature was raised from 30° C. to 435° C. at a rate of 20° C./min, followed by exposure to atmospheric air at 435° C. for 4 hours.

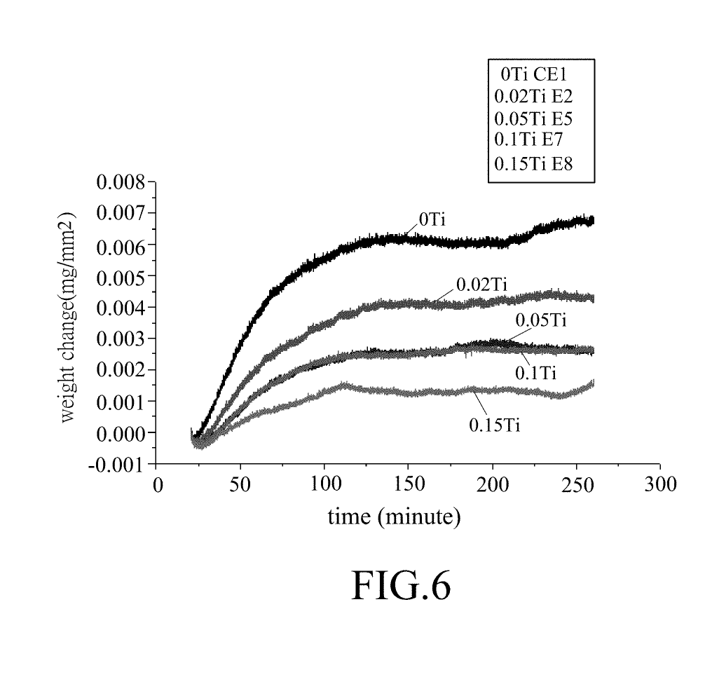

FIG. 6 shows the results of weight change versus time of the lead-free solder composition of each of Comparative Example 1 and Examples 2, 5, 7, and 8. Weight increase is attributed to the oxidation of the lead-free solder composition. The lead-free solder composition with the least amount of weight increase indicates superior oxidation resistance. The weight increase of the lead-free solder composition of Comparative Example 1 (without titanium) is 0.006 mg/mm². The weight increase of the lead-free solder composition of Example 2 (including 0.02 parts by weight of titanium) is approximately 0.004 mg/mm², demonstrating that the degree of oxidation is suppressed to two-thirds of that of Comparative Example 1. The weight increase of the lead-free solder composition of Example 5 (including 0.05 parts by weight of titanium) is 0.0025 mg/mm², demonstrating that the degree of oxidation has been substantially reduced to more than half of that of Comparative Example 1. The weight increase of the lead-free solder composition of each of Examples 5 and 7 (including 0.05 and 0.1 parts by weight of titanium, respectively) is similar, and indicates a similar level of oxidation resistance.

The results in FIG. 6 show that the weight increase of the lead-free solder composition of each of Examples 2, 5, 7, and 8 is significantly less than the weight increase of the lead-free solder composition of Comparative Example 1, demonstrating that the lead-free solder composition of the disclosure is not as easily oxidized and has relatively greater oxidation resistance. The results also show that, in most cases, the greater the amount of titanium in the lead-free solder composition of the disclosure, the greater the oxidation resistance.

In addition to using weight change as an evaluation method of the lead-free solder composition, the inventors further analyzed the composition of surface oxides and found that the greater the amount of titanium in the lead-free solder composition, the less the amount of zinc in the surface oxide. This finding suggests that the lead-free solder composition including titanium may effectively inhibit the oxidation of zinc.

### Tensile Strength Test

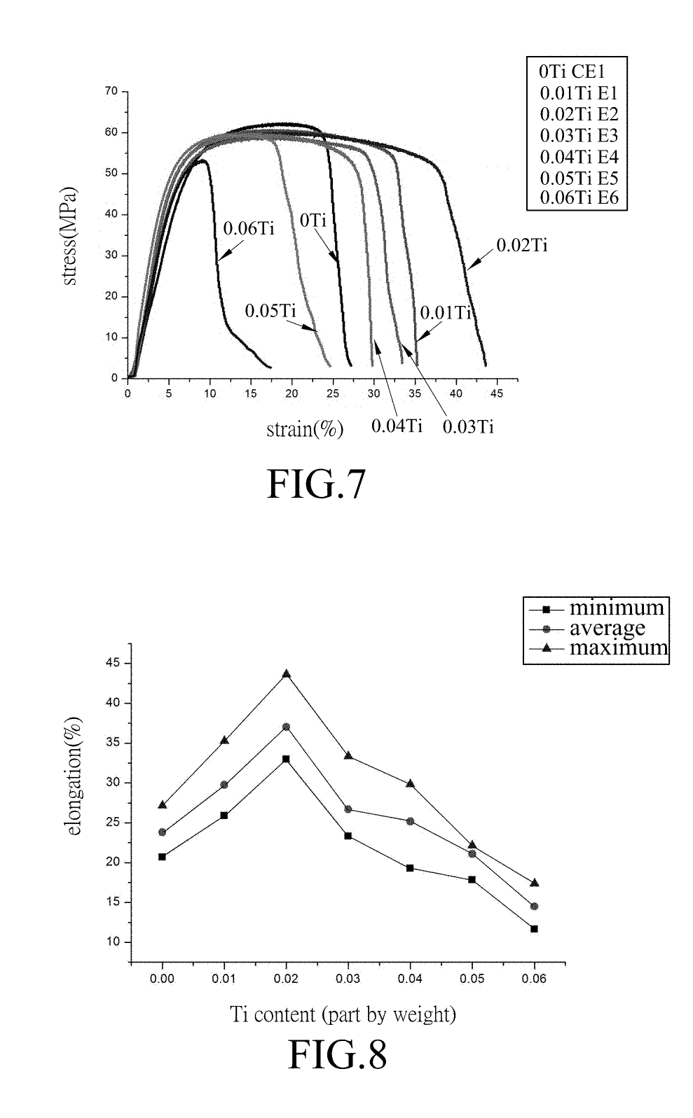

A sample of the lead-free solder composition of each of Examples 1 to 6 and Comparative Example 1 was subjected to a tensile strength test in accordance with test method ASTM 370. The results of the tensile strength test are listed in Table 1 and plotted in FIGS. 7 to 9. Examples 7 and 8 are mainly concerned with demonstrating the oxidation resistance and level of grain refinement of the lead-free solder composition of the disclosure, and thus were not subjected to the tensile strength test.

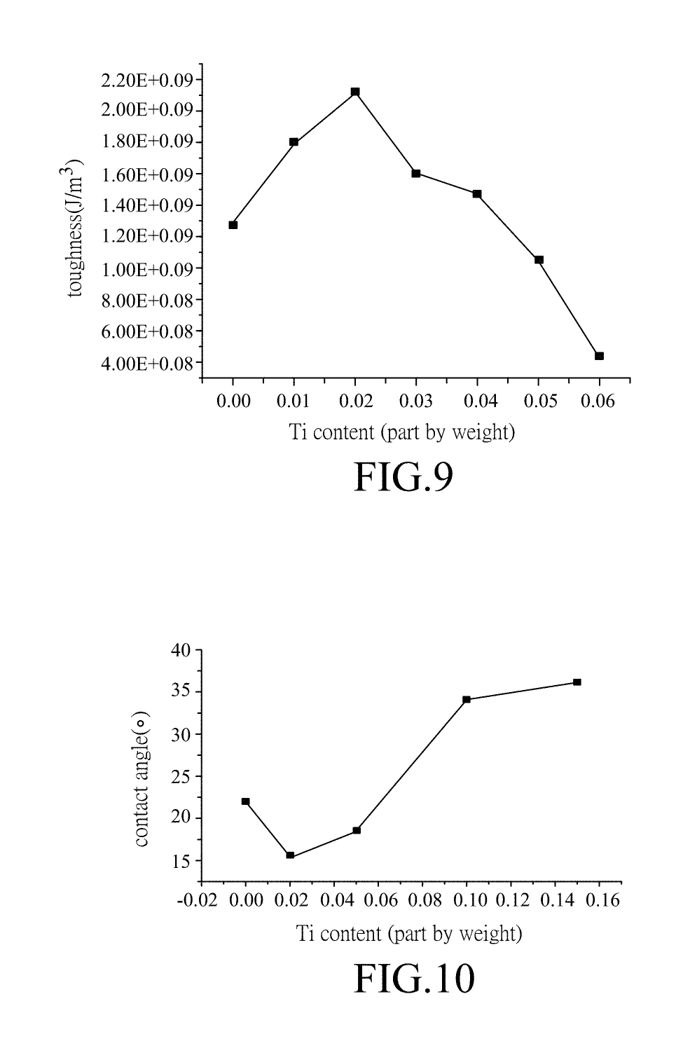

An area under the stress-strain curve of each of Examples 1 to 6 and Comparative Example 1 (see FIG. 7) was calculated to obtain a toughness of the lead-free solder composition of each of Examples 1 to 6 and Comparative Example 1 (See Table 1 and FIG. 9). The elongation percentage, as a measure of ductility, of the lead-free solder composition of each of Examples 1 to 6 and Comparative Example 1, is listed in Table 1 and plotted in FIG. 8. As shown in FIGS. 7 and 8 and Table 1, when the amount of titanium ranges from 0.01 to 0.03 parts by weight, the toughness and ductility of the lead-free solder composition are greater than those of the lead-free solder composition of Comparative Example 1. It should be noted that, compared to Comparative Example 1, the toughness and ductility of Example 2 are notably increased by 66%

$$( \frac{( 2117 - 1272 )}{1272} \times 100 \% ≅ 66 \% ) and$$

$$56 \% ( \frac{( 37.02 \% - 23.8 \% )}{23.8 \%} \times 100 \% ≅ 56 \% ) ,$$

respectively.

### Wettability Test

A sample of the lead-free solder composition of each of Examples 2, 5, 7, and 8 and Comparative Example 1 was subjected to a wettability test using a wetting balance analysis method. To be specific, each of the test samples was placed in a tank and heated to 435° C. to obtain a molten solution. A copper material was inserted into the molten solution at a rate of 15 mm/s until reaching a depth of 9.9 mm, and then maintained for 10 seconds.

FIG. 10 shows the results of the amount of titanium versus the contact angle of the lead-free solder composition of each of Examples 2, 5, 7, and 8 and Comparative Example 1. As shown in FIG. 10, the contact angle of each of Examples 2 and 5 (including 0.02 and 0.05 parts by weight of titanium, respectively) is smaller than that of Comparative Example 1. This finding demonstrates that the lead-free solder composition of the disclosure with titanium in an amount ranging from 0.01 to 0.06 parts by weight exhibits increased wettability with respect to copper, and is therefore suitable for metal welding and soldering.

TABLE 1

| | Components | | | | Tensile | |
|---|---|---|---|---|---|---|
| | (parts by weight) | | | Elongation | strength | Toughness |
| | Ti | Sn | Zn | (%) | (Mpa) | (10⁶ J/m²) |
| E1 | 0.01 | 25 | 74.99 | 29.76 | 58.79 | 1791.21 |
| E2 | 0.02 | 25 | 74.98 | 37.02 | 58.91 | 2117.28 |
| E3 | 0.03 | 25 | 74.97 | 26.7 | 59.17 | 1592.59 |
| E4 | 0.04 | 25 | 74.96 | 25.18 | 59.19 | 1475.65 |
| E5 | 0.05 | 25 | 74.95 | 21.09 | 59.71 | 1049.46 |
| E6 | 0.06 | 25 | 74.94 | 14.51 | 54.67 | 441.66 |
| E7 | 0.1 | 25 | 74.90 | — | — | — |
| E8 | 0.15 | 25 | 74.85 | — | — | — |
| CE1 | 0 | 25 | 75 | 23.8 | 60.62 | 1272.17 |

In summary, with the inclusion of 0.01 to 0.15 parts by weight of titanium in the lead-free solder composition of the disclosure, the oxidation resistance and number of fine grains of the lead-free solder composition may be increased. In addition, when titanium is present in the lead-free solder composition in an amount ranging from 0.01 to 0.03 parts by weight, the ductility, tensile strength, toughness and wettability of the lead-free solder composition may further be improved. Moreover, when titanium is present in the lead-free solder composition in an amount of 0.02 parts by weight, the lead-free solder composition of the disclosure has optimal ductility, toughness and wettability.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A lead-free solder composition comprising tin, titanium and zinc,
wherein, based on 100 parts by weight of the total weight of tin, titanium and zinc, tin is present in an amount ranging from 20 to 40 parts by weight, and titanium is present in an amount ranging from 0.01 to 0.15 parts by weight.

2. The lead-free solder composition of claim 1, wherein titanium is present in an amount ranging from 0.01 to 0.05 parts by weight based on 100 parts by weight of the total weight of tin, titanium and zinc.

3. The lead-free solder composition of claim 1, wherein titanium is present in an amount ranging from 0.01 to 0.03 parts by weight based on 100 parts by weight of the total weight of tin, titanium and zinc.

4. The lead-free solder composition of claim 1, wherein tin is present in 25 parts by weight based on 100 parts by weight of the total weight of tin, titanium and zinc.
